(19) United States
(12) Patent Application Publication
(10) Pub. No.: US 2003/0097411 A1
(43) Pub. Date: May 22, 2003

(54) Method and apparatus for providing caller ID information with voicemail services supplied by the phone company

(76) Inventor: Louis Robert Litwin, Middlesex, NJ (US)

Correspondence Address: JOSEPH S. TRIPOLI, THOMSON MULTIMEDIA LICENSING INC., 2 INDEPENDENCE WAY, P.O. BOX 5312, PRINCETON, NJ, 08543-5312, US

(21) Appl. No.: 09/988,514

(22) Filed: Nov. 20, 2001

(51) Int. Cl. G06F 15/16; H04M 11/10

(52) U.S. Cl. 709/206; 455/413

(57) ABSTRACT

In a voicemail service system having a voicemail mailbox and a caller ID device that are remote from a user of the voicemail service system, there is provided a method for providing caller ID information to the user. A call to the user from another party is received, when a phone of the user is already in use (310). Caller ID information for the call is stored for subsequent playback to the user (320). The storing step may be performed irrespective of whether the other party leaves a voicemail message for the user.

### BACKGROUND

1. Technical Field

The present invention generally relates to voicemail communications and, in particular, to a method and apparatus for providing caller ID information with voicemail services that are supplied by the phone company.

2. Background Description

When a user is on the phone or online with a computer, incoming callers will not reach the user's home answering machine. Phone companies provide voicemail services where the caller's voicemail message is stored at the phone company. The user dials a number and types in a pass code to play back the voicemail message. However, if the caller doesn't leave a voicemail message, the user will not know that he received a call. Also, he will not be able to retrieve any caller ID information (caller name, caller number, date and time of call) from the phone company's service.

Accordingly, it would be desirable and highly advantageous to have a method and apparatus for providing caller ID information with voicemail services that are supplied by the phone company, particularly when a caller calls a user but does not leave a voicemail message.

### SUMMARY OF THE INVENTION

The problems stated above, as well as other related problems of the prior art, are solved by the present invention, a method and apparatus for providing caller ID information with voicemail services that are supplied by the phone company.

Advantageously, the present invention not only provides call information (caller name, caller number, date and time of call) for calls with messages, but the present invention also allows the user to get call information about callers that did not leave a message. Moreover, the present invention allows users to have caller ID service without purchasing the additional Caller ID box similar to the way that the current voicemail system allows users to have voicemail capability without purchasing an answering machine.

According to an aspect of the present invention, in a voicemail service system having a voicemail mailbox and a caller ID device that are remote from a user of the voicemail service system, there is provided a method for providing caller ID information to the user. A call to the user from another party is received, when a phone of the user is already in use. Caller ID information for the call is stored for subsequent playback to the user.

According to another aspect of the present invention, the storing step is performed irrespective of whether the other party leaves a voicemail message for the user.

These and other aspects, features and advantages of the present invention will become apparent from the following detailed description of preferred embodiments, which is to be read in connection with the accompanying drawings.

### BRIEF DESCRIPTION OF THE DRAWINGS

FIG. 1 is a block diagram of a computer processing system 100 to which the present invention may be applied according to an illustrative embodiment thereof;

FIG. 2 is a block diagram illustrating a communication system to which the present invention may be applied, according to an illustrative embodiment of the present invention; and

FIG. 3 is a flow diagram illustrating a method for providing caller ID information with voicemail services that are supplied by the phone company, according to an illustrative embodiment of the present invention.

### DETAILED DESCRIPTION OF PREFERRED EMBODIMENTS

The present invention is directed to a method and apparatus for providing caller ID information with voicemail services that are supplied by the phone company.

It is to be understood that the present invention may be implemented in various forms of hardware, software, firmware, special purpose processors, or a combination thereof. Preferably, the present invention is implemented as a combination of hardware and software. Moreover, the software is preferably implemented as an application program tangibly embodied on a program storage device. The application program may be uploaded to, and executed by, a machine comprising any suitable architecture. Preferably, the machine is implemented on a computer platform having hardware such as one or more central processing units (CPU), a random access memory (RAM), and input/output (I/O) interface(s). The computer platform also includes an operating system and microinstruction code. The various processes and functions described herein may either be part of the microinstruction code or part of the application program (or a combination thereof) that is executed via the operating system. In addition, various other peripheral devices may be connected to the computer platform such as an additional data storage device and a printing device.

It is to be further understood that, because some of the constituent system components and method steps depicted in the accompanying Figures are preferably implemented in software, the actual connections between the system components (or the process steps) may differ depending upon the manner in which the present invention is programmed. Given the teachings herein, one of ordinary skill in the related art will be able to contemplate these and similar implementations or configurations of the present invention.

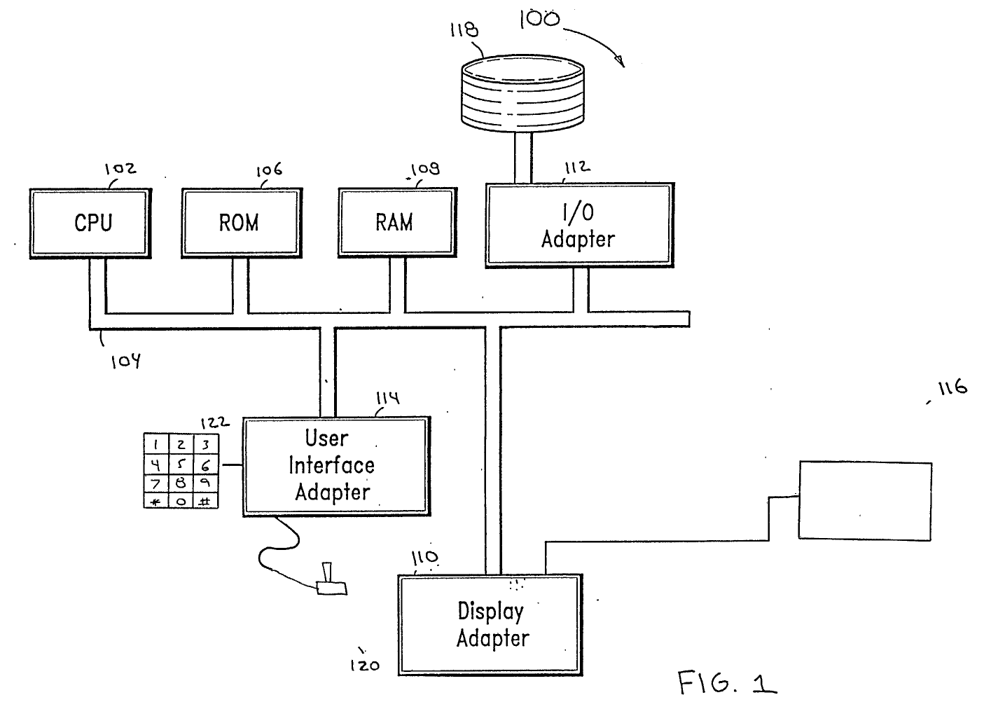

FIG. 1 is a block diagram of a computer processing system 100 to which the present invention may be applied according to an illustrative embodiment thereof. The computer processing system 100 includes at least one processor (CPU) 102 operatively coupled to other components via a system bus 104. A read only memory (ROM) 106, a random access memory (RAM) 108, a display adapter 110, an I/O adapter 112, and a user interface adapter 114 are operatively coupled to the system bus 104.

A display device 116 is operatively coupled to the system bus 104 by the display adapter 110. A disk storage device (e.g., a magnetic or optical disk storage device) 118 is operatively coupled to the system bus 104 by the I/O adapter 112.

A selection device (e.g., mouse, joystick, and so forth) 120 and keyboard 122 are operatively coupled to the system bus 104 by the user interface adapter 114. The selection device 120 and keyboard 122 may be used to input/output information to/from the computer processing system 100.

Phone companies provide voicemail services where the caller's voicemail is stored at the phone company. If the user is on the phone (either talking or logged on with a computer), the incoming caller cannot get to the user's answering machine/caller ID unit. Instead, the caller is sent to a voicemail service supplied by the phone company. The caller's message (if he or she chooses to leave one) is stored at the phone company. The user can check to see if he or she has any messages by picking up his or her phone. If the user has messages stored on the phone company's voicemail system, the user will hear a different dial tone (typically a triple tone). The user can then call a number to access the voicemail system and replay his or her messages.

Advantageously, the present invention extends that concept to include caller ID information (caller name, caller number, date and time of call). This caller ID information would also be stored at the phone company and the user could access the caller ID information the same way that the user accesses his or her voicemail messages in the current system. This would provide the user with many benefits. For example, the user would be able to hear caller ID information for any voicemail message that the user has. Further, the user would know if he or she had any missed calls. The user would not only know that someone called and did not leave a message, but the user would also have their caller ID information in case the user wanted to call them back.

This service would work the same way as the phone company voicemail system. Suppose the user is logged onto the Internet with his or her computer. Someone calls but does not leave a message. When the user logs off, the user picks up his or her phone and hears the special ring. The user dials the number for his or her phone company's voicemail system, and is told that he or she had an incoming call. Even though there is no message, the service will tell the user the name and number of the caller as well as the date and time of the call.

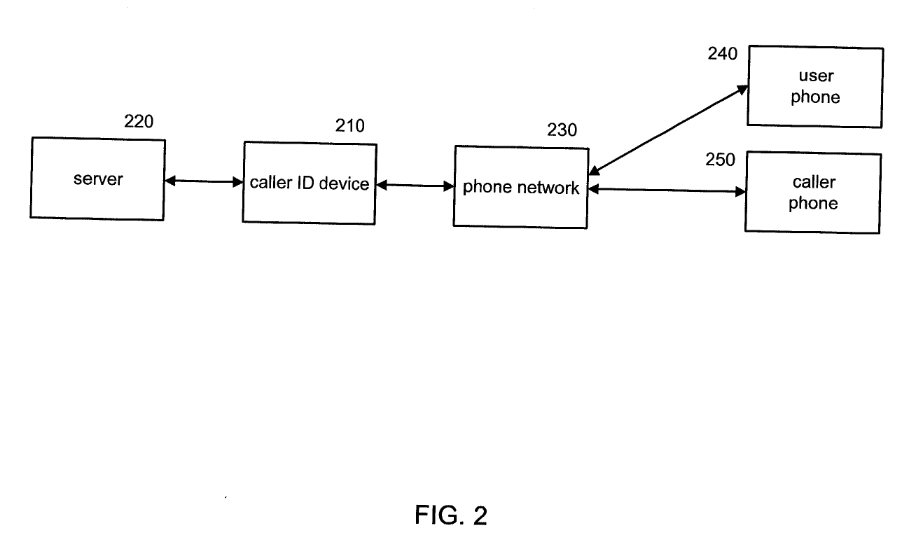

FIG. 2 is a block diagram illustrating a communication system to which the present invention may be applied, according to an illustrative embodiment of the present invention. The system includes a caller ID device 210; a server 220; and a phone network 230.

The phone network 230 provides a communication medium between the phone of a user (hereinafter “user phone”) 240 and the phone of a caller (hereinafter “caller phone”) 250. The phone network 230 also provides a communication medium to the server 210.

The caller ID device 210 generates caller ID information for any calls to the user. The caller ID information may be generated by the caller ID device 210 irrespective of whether the caller leaves a voicemail message.

The server 210 stores voicemail messages. The server 210 also stores caller ID information corresponding to the voicemail messages and caller ID information corresponding to calls for which no voicemail message was left.

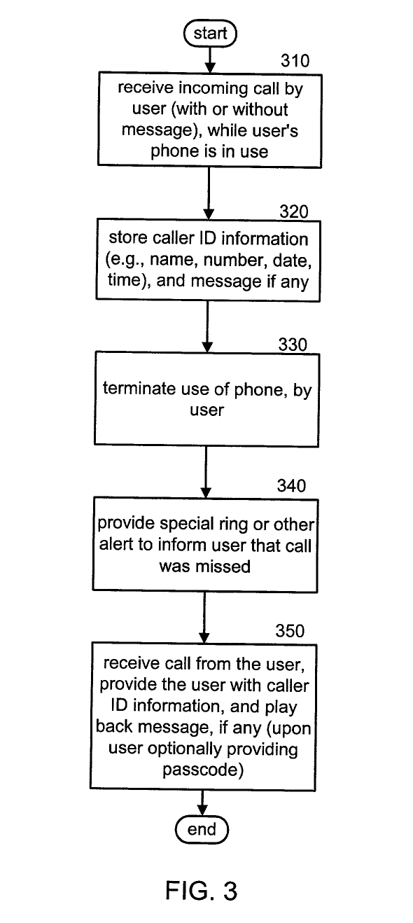

FIG. 3 is a flow diagram illustrating a method for providing caller ID information with voicemail services that are supplied by the phone company, according to an illustrative embodiment of the present invention.

The user receives an incoming call on his or her phone 240, while the phone 240 is in use (e.g., the user may be on a call, or logged onto the Internet through a dial-up connection) (step 310). The caller may or may not leave a message.

The caller ID information (e.g., caller name, caller number, date of call, time of call) corresponding to the call is stored in the server 220 (step 320). Preferably, the caller ID information is stored in the server 220 along with the voicemail message, if the caller leaves a voicemail message.

The user terminates use of his or her phone 240 (step 330). A special ring or other alert is provided by the phone 240 to inform the user that a call was missed (step 340).

Upon the user dialing a predetermined number (e.g., his or her typical voicemail mailbox number), a call is received from the user and the user is provided with the caller ID information for the missed call (step 350). The user may optionally provide a pass code prior to receiving the caller ID information.

Although the illustrative embodiments have been described herein with reference to the accompanying drawings, it is to be understood that the present invention is not limited to those precise embodiments, and that various other changes and modifications may be affected therein by one of ordinary skill in the related art without departing from the scope or spirit of the invention. All such changes and modifications are intended to be included within the scope of the invention as defined by the appended claims.

What is claimed is:

1. In a voicemail service system having a voicemail mailbox and a caller ID device that are remote from a user of the voicemail service system, a method for providing caller ID information to the user, comprising the steps of:
receiving a call to the user from another party, when a phone of the user is already in use; and
storing caller ID information for the call for subsequent playback to the user.

2. The method of claim 1, wherein said storing step is performed irrespective of whether the other party leaves a voicemail message for the user.

3. The method of claim 1, further comprising the step of providing a distinct dial tone to the user that indicates a receipt of the call, upon the user terminating the use of the phone.

4. The method of claim 1, wherein said receiving step comprises the step of receiving a voicemail message for the user from the other party, said storing step comprises the step of storing the voicemail message, and said method further comprises the step of playing back the voicemail message to the user.

5. The method of claim 4, wherein said playing back step comprises the step of verifying a pass code provided by the user.

6. The method of claim 1, further comprising the step of playing back the caller ID information to the user, irrespective of whether the user has personal access to a caller ID device for generating the caller ID information.

7. The method of claim 1, wherein the caller ID information comprises a name of the other party.

8. The method of claim 1, wherein the caller ID information comprises a telephone number of the other party.

9. The method of claim 1, wherein the caller ID information comprises a date of the call.

10. The method of claim 1, wherein the caller ID information comprises a time of the call.

11. In a voicemail service system, an apparatus for providing caller ID information to a user who is remote from the apparatus, the apparatus comprising:
a caller ID device for generating caller ID information for a call to the user from another party, the call being made when a phone of the user is already in use; and
a server for storing the caller ID information for the call for subsequent playback to the user.

12. The apparatus of claim 10, wherein said caller ID device generates the caller ID information for the call and said server stores the caller ID information for the call irrespective of whether the other party leaves a voicemail message for the user during the call.

13. The apparatus of claim 10, wherein said server stores a voicemail message provided during the call.

14. The apparatus of claim 12, wherein the voicemail message and the caller ID information are stored together in said server.

15. The apparatus of claim 10, wherein the caller ID information comprises a name of the other party.

16. The apparatus of claim 10, wherein the caller ID information comprises a telephone number of the other party.

17. The apparatus of claim 10, wherein the caller ID information comprises a date of the call.

18. The apparatus of claim 1, wherein the caller ID information comprises a time of the call.
